(19) United States
(12) Patent Application Publication
(10) Pub. No.: US 2026/0042317 A1
(43) Pub. Date: Feb. 12, 2026

(54) WHEEL HUB ASSEMBLY AND METHODS

(71) Applicant: Consolidated Metco, Inc., Vancouver, WA (US)

(72) Inventor: Connor Regan, Vancouver, WA (US)

(21) Appl. No.: 19/294,910

(22) Filed: Aug. 8, 2025

Related U.S. Application Data
(60) Provisional application No. 63/680,750, filed on Aug. 8, 2024.
(60) Provisional application No. 63/680,870, filed on Aug. 8, 2024.

(51) Int. Cl. B60B 27/00

(52) U.S. Cl. CPC B60B 27/001; B60B 27/0073; B60B 27/0078; B60B 2310/316; B60B 2320/16; B60B 2380/14

(57) ABSTRACT

In one aspect, a wheel hub assembly having a wheel hub body, an inboard bearing assembly, an outboard bearing assembly, and a seal. The inboard bearing assembly has a radially outer ring mounted to the wheel hub body, a radially inner ring, and a plurality of bearing elements that permit the radially outer ring to rotate relative to the radially inner ring. The seal includes a seal case mounted to the wheel hub body and a sleeve having a sleeve body mounted to the radially inner ring of the inboard bearing assembly. The sleeve body extends inboard from the radially inner ring and is configured to extend along the spindle and be spaced radially therefrom with the inboard and outboard bearing assemblies rotatably connecting the wheel hub body to the spindle.

### CROSS-REFERENCE TO RELATED APPLICATIONS

This application claims the benefit of U.S. Provisional Application No. 63/680,750, filed Aug. 8, 2024 and U.S. Provisional Application No. 63/680,870, filed Aug. 8, 2024, both of which are hereby incorporated herein by reference in their entirety.

### TECHNICAL FIELD

This disclosure relates to wheel hub assemblies for vehicles and, more specifically, relates to wheel hub assemblies having seals to protect bearing assemblies of the wheel hub assemblies.

### BACKGROUND

Wheel hub assemblies, sometimes referred to as wheel ends, are used to connect wheels to axles of vehicles. The use of a pre-adjusted wheel hub assembly with an axle may involve a no-back-off installation of the wheel hub assembly onto a spindle of the axle. The wheel hub assembly may include one or more seals for protecting one or more bearing assemblies of the wheel hub assembly.

Many wheel hub assemblies include a wheel hub and an inboard cassette seal having a rotatably connected sleeve and seal case. The seal case includes an oil-sealing main lip that engages the sleeve and urges water, dirt, and other debris near the inboard seal away from the interior of the wheel hub as the vehicle moves.

To install the wheel hub assembly on a spindle, the inboard cassette seal is first inserted into a seal bore of the wheel hub of the wheel hub assembly. At this point, the sleeve of the inboard cassette seal is not in its final operating position.

The wheel hub assembly, which includes the inboard cassette seal in the seal bore of the wheel hub, is advanced onto the vehicle spindle and a spindle nut of the wheel hub assembly is tightened to apply an axial force against the wheel hub to shift the wheel hub and inboard cassette seal therein axially in an inboard direction along the spindle to an operative position on the spindle. The axial force applied by the spindle nut overcomes interference between the sleeve and the spindle. However, due to the metal-to-metal contact between sleeve and the spindle, a significant axial force is required to advance the sleeve onto the vehicle spindle (e.g., 4,000 pound-force (lbf)) which makes installation of the hub-seal assembly difficult.

As a result of the interference between the sleeve and the journal, when the spindle locknut is tightened, an axial force acts against the sleeve, compressing the sleeve against the seal case which must later rotate relative to the sleeve during vehicle operation. The traditional engineering solution is to incorporate a sacrificial bumper axially between the sleeve and seal case to bear the axially-directed installation force between the sleeve and the seal case. The sacrificial bumper wears away during operation of the vehicle until a clearance is formed between the sleeve and the seal case. This wearing or bedding-in process can generate extreme temperatures in excess of 600° F. which can be detrimental to the long-and short-term performance of the main sealing lip of the seal case and may lead to premature failure of the main sealing lip. The seal engineer, when utilizing a sacrificial bumper, must be cautious not to over-specify the interference fit between sleeve inner diameter and the spindle journal. A larger amount of interference leads to a higher axial load as the hub-seal assembly is installed on the axle journal. A higher axial load on the sacrificial bumper may lead to increased risk of failure in the case of a fractured or over-worn bumper, and in general may lead to higher operating temperatures.

The bedding-in process of the sacrificial bumper also has a negative impact on the fuel economy of the vehicle. Specifically, the contact between the sacrificial bumper, the sleeve, and the seal case accounts for a significant portion of the overall drag torque of a wheel hub assembly.

The interference fit of the sleeve with the vehicle spindle can also cause removal of the wheel hub-seal assembly from the vehicle spindle to be difficult. For instance, due to the high axial force required to move the sleeve along the vehicle spindle, the seal may be damaged during the removal process.

### BRIEF DESCRIPTION OF DRAWINGS

FIG. 1 is a cross-sectional view of a wheel hub assembly including inboard and outboard bearing assemblies and a seal inboard of the inboard bearing assembly.

FIG. 2 is an enlarged view of a portion of the wheel hub assembly of FIG. 1 showing the inboard bearing assembly and a sleeve and a seal case of the seal.

FIG. 3 is a perspective, cross-sectional view of a portion of the wheel hub assembly of FIG. 1 showing the sleeve, the seal case, and the bearing assembly.

FIGS. 4A-4E are a series of cross-sectional views showing a first method for installing the seal of FIG. 1 in a wheel hub.

FIGS. 5A-6D are a series of cross-sectional views showing a second method for installing the seal of FIG. 1 in a wheel hub.

FIG. 7 is a cross-sectional view of another embodiment of a wheel hub assembly having a seal.

### DETAILED DESCRIPTION

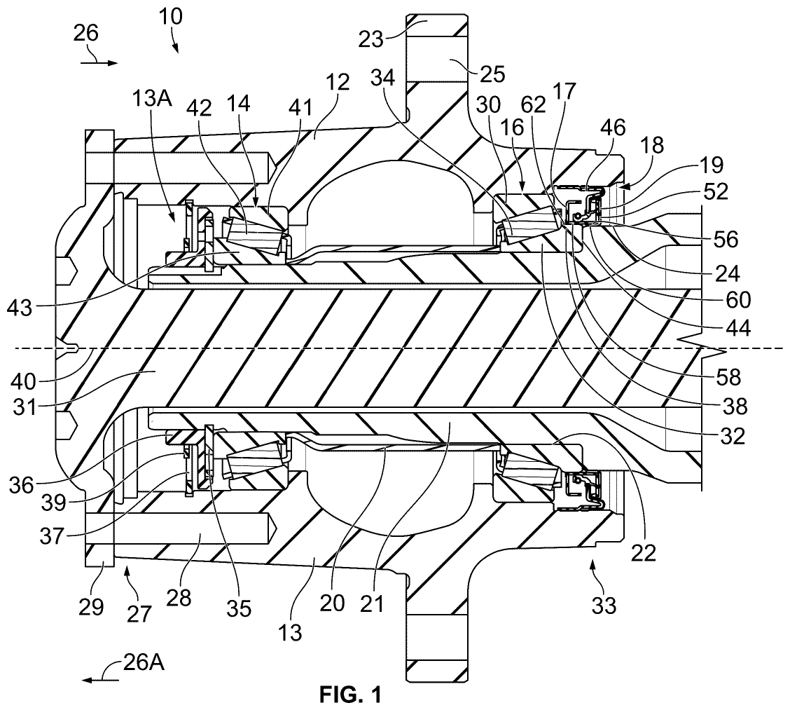

Regarding FIG. 1, a wheel hub assembly 10 is provided that includes a wheel hub 12 having a hub body 13, an outboard bearing assembly 14, an inboard bearing assembly 16, a cassette seal such as seal 18, and a spacer 20. The outboard and inboard bearing assemblies 14, 16 are mounted in an interior 13A of the hub body 13 and permit the hub body 13 to rotate around central axis 40. The wheel hub assembly 10 is assembled onto a vehicle spindle 21, which may include a seal journal 24, by aligning a central bore 22 of an inboard bearing assembly 16 of the wheel hub assembly 10 with an outboard end of the spindle 21 and advancing the wheel hub assembly 10 in direction 26 along an outer surface of the spindle 21. Once the wheel hub assembly 10 has been mounted to the vehicle spindle 21, an axle shaft 31 is positioned to extend in the vehicle spindle 21 and is connected to the wheel hub 12 for rotating the wheel hub 12 and wheel mounted thereto.

The seal 18 has an outboard side 17, an inboard side 19, and includes a seal case 46 and a sleeve 52. The sleeve 52 has a central opening 60 to receive the seal journal 24 of the vehicle spindle 21 and a portion of the inboard bearing assembly 16. The sleeve 52 includes an inboard mounting portion 56 sized to receive the seal journal 24 and an outboard mounting portion 58 sized to receive an inboard bearing cone 32 of the inboard bearing assembly 16 and form an interference fit therewith. The inner diameter of the outboard mounting portion 58 may be larger than the inner diameter of the inboard mounting portion 56.

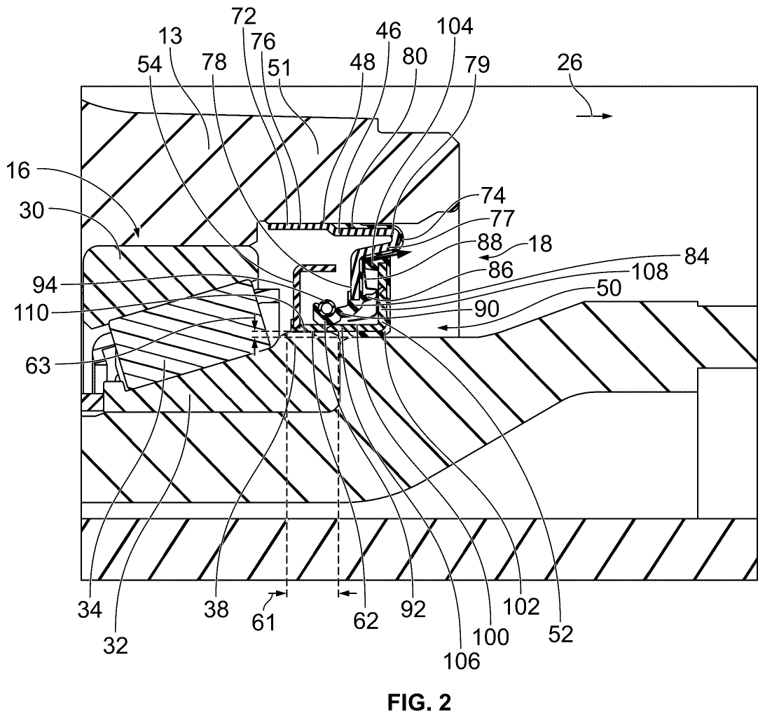

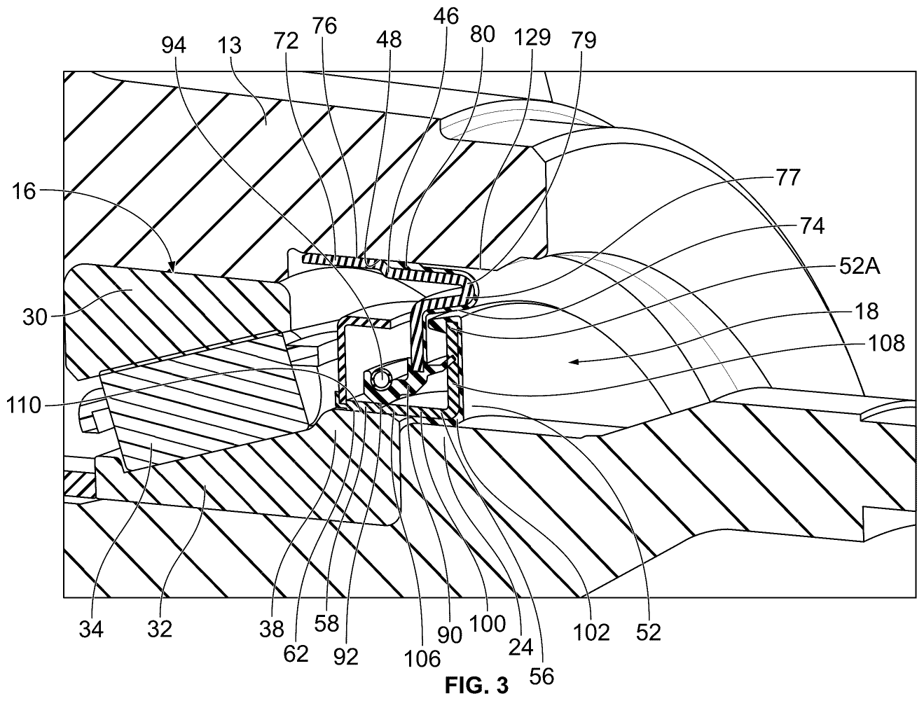

The inboard bearing assembly 16 includes an outer ring, such as an inboard bearing cup 30, an inner ring, such as the inboard bearing cone 32, and bearing elements such as ball bearings or roller bearings 34. Regarding FIG. 2, the inboard bearing cone 32 includes a flange portion 38 having an engagement surface 62. The flange portion 38 is an extension of the inboard bearing cone 32 and has a length 61. The length 61 of the flange portion 38 may be in a range of about 4 mm to about 12 mm. As one example, the length 61 of the flange portion 38 is 8.25 mm. The flange portion 38 extends radially outward with the engagement surface 62 being a distance 63 radially outward beyond the seal journal 24. The distance 63 that the engagement surface 62 is radially outward of the seal journal 24 may be in a range of about 0.5 mm to about 3.5 mm. As one example, the distance 63 is 1 mm. The engagement surface 62 has a diameter sized to interfere with an inner diameter of the outboard mounting portion 58 of the sleeve 52. In this manner, there is a press-fit engagement between the inboard bearing cone 32 and the sleeve 52 which secures the sleeve 52 relative to the inboard bearing cone 32.

With reference to FIG. 1, the hub body 13 of the wheel hub 12 includes a wheel mounting portion, such as a flange 23, for mounting a wheel thereto. The flange 23 may include a plurality of openings 25 that receive fasteners, or may have fasteners embedded therein, for extending through openings of a wheel and receiving lug nuts. The hub body 13 further includes an inboard end portion 33 and an outboard end portion 27. The outboard end portion 27 has attachment openings 28 to receive fasteners, such as bolts, to secure a flange 29 of the axle shaft 31 to the hub body 13. The wheel hub assembly 10 further includes a retainer assembly to maintain the wheel hub assembly 10 on the spindle 21. The retainer assembly may include a lock washer 35, a spindle nut 36, a double wind snap ring 37, and a snap ring retainer 39.

The outboard bearing assembly 14 includes an outboard bearing cup 41, roller bearings 42, and an outboard bearing cone 43. The spacer 20 maintains a predetermined axial separation between the inboard and outboard bearing cones 32, 43. The spindle nut 36 urges the inboard and outboard bearing cones 32, 43 and spacer 20 against a shoulder 44 of the spindle 21. During operation of the vehicle, the axle shaft 31 rotates to generate rotation of the hub body 13 and the wheel attached to the flange 29. Rotation of the hub body 13 generates rotation of the inboard and outboard bearing cups 30, 41 and roller bearings 34, 42 while the inboard and outboard bearing cones 32, 43 and spacer 20 generally remain stationary relative to the spindle 21.

With respect to FIGS. 2 and 3, the seal case 46 of the seal 18 is engaged with a radially inner surface 48 of the hub body 13 of the wheel hub assembly 10. The hub body 13 may have a unitary, one-piece construction and may be made of a metallic material such as steel, iron, or aluminum as some examples. The hub body 13 has a central through opening 50 and a tubular side wall 51 extending about the central through opening 50 and having the radially inner surface 48. The seal case 46 has an outer diameter sized to form a press-fit engagement with the hub body radially inner surface 48 that fixes the seal case 46 against rotary and axial movement relative to the hub body 13. The seal case 46 includes a body 72 and a sealing member 74. The body 72 may be made of a metallic material, such as steel. The sealing member 74 may be made of a polymeric material, such as an elastomeric material such as rubber. Other examples include plastics and/or resins, such as polytetrafluoroethylene.

Regarding FIG. 2, the body 72 of the seal case 46 has a radially outer portion 76, an intermediate portion 77 that may include a bend 79, and a radially inner portion 78. The radially outer portion 76 of the body is engaged with the radially inner surface 48 of the wheel hub body 13 and the sealing member 74 includes a radially outer portion 80 engaged with the radially inner surface 48 of the wheel hub body 13. In one embodiment, the body 72 is steel or aluminum and the sealing member 74 is rubber. The engagement of the radially outer portion 76 of the body 72 with the radially inner surface 48 of the wheel hub body 13 forms a metal-to-metal interference fit connection. The pull-out force needed to remove the seal case 46 for a given application may be reduced by having a shorter axial extent of the radially outer portion 76 of the body 72 or increased by having a longer axial extent of the radially outer portion 76 of the body 72.

The sealing member 74 may include the radially outer portion 80 and a radially inner portion 84. The radially outer portion 80 engages the radially inner surface 48 of the hub body 13 to form a seal therebetween. The radially inner portion 84 of the sealing member 74 may include one or more walls 86 that form a portion of a tortuous path 88 between the seal case 46 and the sleeve 52. The wall 86 may contact the sleeve 52 to inhibit the ingress of fluid and debris into the wheel hub assembly 10. The radially inner portion 84 of the sealing member 74 also includes a sealing portion 90 that engages the sleeve 52. In one embodiment, the seal 18 includes a resilient member, such as a garter spring 94, that holds a main lip 92 of the sealing portion 90 in contact with the sleeve 52. Regarding FIG. 3, the main lip 92 may be positioned to contact a radially outer surface of the outboard mounting portion 58 of the sleeve 52. In other words, the main lip 92 may be aligned in a radial direction with the engagement surface 62 of the inboard bearing cone 32. The contact between the main lip 92 and the sleeve 52 generates heat as the seal case 46 rotates relative to the sleeve 52 during operation of the vehicle. The heat may be conducted to the inboard bearing cone 32 and spindle 21 through the outboard mounting portion 58 of the sleeve 52.

Regarding FIG. 2, the sleeve 52 includes a body 100 made of a metallic material, such as steel, and a sealing member 102 secured therewith. The sealing member 102 may be made of a polymeric material, such as an elastomeric material such as rubber. Other examples include plastics and/or resins, such as polytetrafluoroethylene. The body 100 directly contacts the engagement surface 62 of the inboard bearing cone 32 and conducts heat generated by the contact between the sealing portion 90 and the body 100 to the inboard bearing cone 32. The sealing portion 90 is positioned to contact the portion of the body 100 mounted on the inboard bearing cone 32 such that the sealing portion 90 is radially outward of the inboard bearing cone 32. The inboard bearing cone 32 contacts the spindle 21, which is a large metallic part that operates as heat sink. In this manner, heat is able to flow from the body 100 to the spindle 21 via the inboard bearing cone 32 and be dissipated, which improves the durability of the sealing member 74.

Regarding FIG. 3, the sealing member 102 engages the seal journal 24 of the vehicle spindle 21 to form a seal therebetween. The sealing member 102 is positioned between the body 100 and the spindle 21 such that the metallic body 100 is spaced from and does not directly contact the spindle 21. The sealing member 102 takes up the radial gap between the body 100 and the spindle 21.

Regarding FIG. 2, the seal journal 24 may have a smaller outer diameter than the flange portion 38 of the inboard bearing cone 32 as shown by the distance 63. The sealing member 102 may have a smaller minimum inner diameter than the minimum inner diameter of the body 100 at the outboard mounting portion 58 to engage the seal journal 24.

The sealing member 102 extends radially inward from the body 100 of the sleeve 52 to contact the seal journal 24. The polymeric sealing member 102 may contact and slide along the seal journal 24 of the spindle 21 when mounting the wheel hub assembly 10 to the spindle 21 or removing the wheel hub assembly 10 from the spindle 21. When the body 100 of the sleeve 52 has been pressed onto the flange portion 38 of the bearing cone 32, the body 100 is fixed to the bearing cone 32 and the sealing member 102 is held stationary relative to the spindle 21.

Because the sleeve 52 lacks a metal-to-metal interference fit with the spindle 21, a relatively low force may be used to slide the seal 18 along the spindle 21, for example, a force of 50-500 lbf, which may result from application of approximately 2-20 ft-lbf. to the spindle nut 36. The relatively low force to advance the seal 18 inboard along the spindle 21 permits an easier assembly of the wheel hub assembly 10 with the spindle 21 and an easier removal of the wheel hub assembly 10 from the spindle 21 without damaging the seal 18.

The sealing member 102 may also include a protrusion 104 that forms part of the tortuous path 88. The protrusion 104 extends axially from a radially outer end 52A (see FIG. 3) of the sleeve 52 toward the seal case 46. The protrusion 104 extends toward and is spaced from the intermediate portion 77 of the seal case 46.

Regarding FIG. 2, the body 100 of the sleeve 52 has an axially extending portion, such as axial wall portion 106, and a radially extending portion 108. The axial wall portion 106 includes the outboard mounting portion 58 and the inboard mounting portion 56. The axial wall portion 106 has radially inner surface 110 that engages the engagement surface 62 of the inboard bearing cone 32 to form the interference fit connection therebetween. The sealing member 102 extends along the radially extending portion 108 of the body 100 and along the inboard mounting portion 56 of the axial wall portion 106 of the body 100 to engage the seal journal 24.

Regarding FIG. 1, the interference between the axial wall portion 106 of the sleeve 52 and the engagement surface 62 resists movement of the sleeve 52 relative to the inboard bearing cone 32 in directions 26, 26A along the axis 40. For example, the interference fit between the sleeve 52 and the inboard bearing cone 32 inhibits axial, outboard movement of the sleeve 52 in outboard direction 26A relative to the inboard bearing cone 32 as wheel hub assembly 10 is advanced in the inboard direction 26 onto the spindle 21 during installation. Because the sleeve 52 is kept from shifting in direction 26A by the engagement between the sleeve 52 and inboard bearing cone 32, the sleeve 52 remains at a predetermined axial distance from the seal case 46 as the wheel hub assembly 10 is advanced in the inboard direction 26. The frictional resistance due to the engagement of the sealing member 102 of the sleeve 52 with the seal journal 24 is insufficient to overcome the interference fit between the sleeve 52 and the inboard bearing cone 32.

Regarding FIG. 2, the seal 18 includes a retainer 54 that captures the radially inner portion 78 of the seal case between the retainer 54 and the radially extending portion 108 of the sleeve 52. In this manner, the retainer 54 keeps the seal case 46 and sleeve 52 assembled prior to assembly of the seal 18 with the hub body 13.

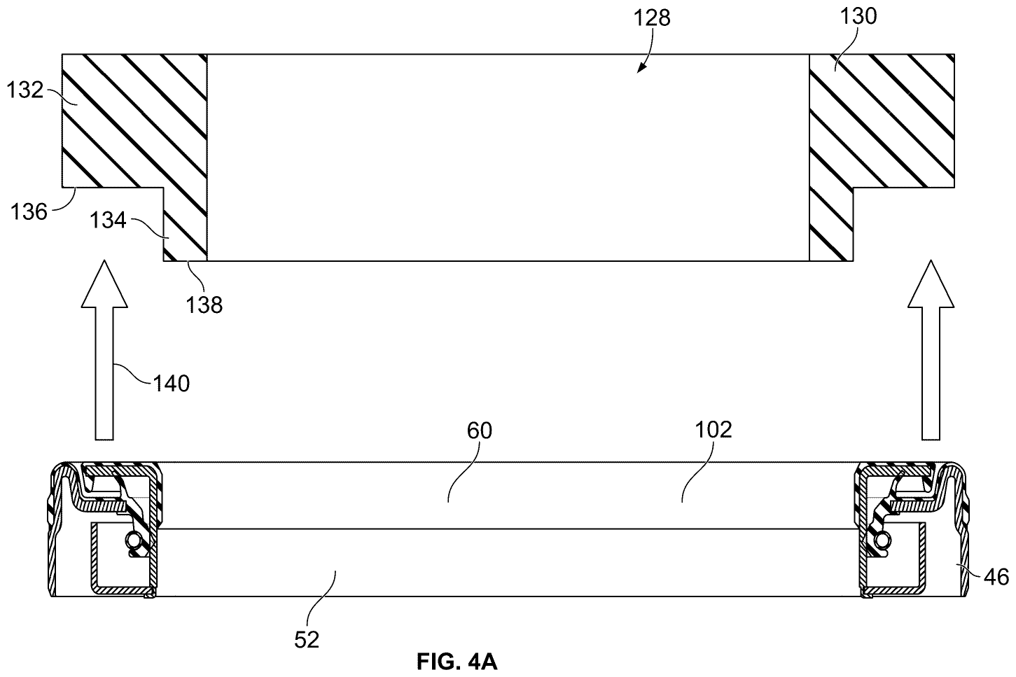

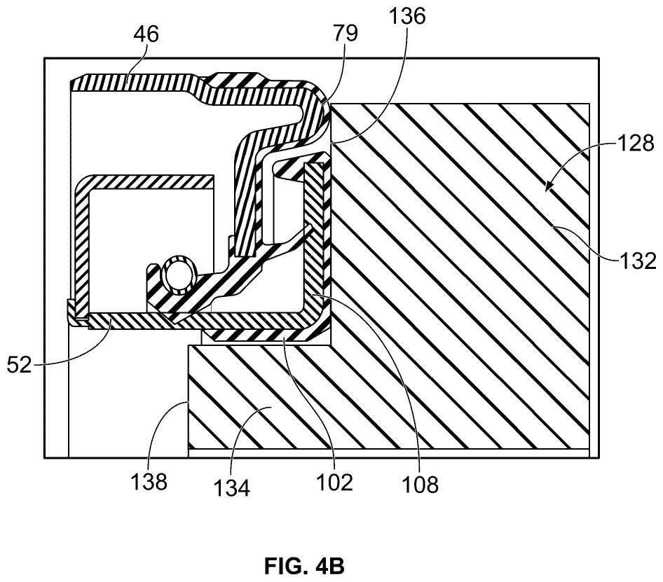

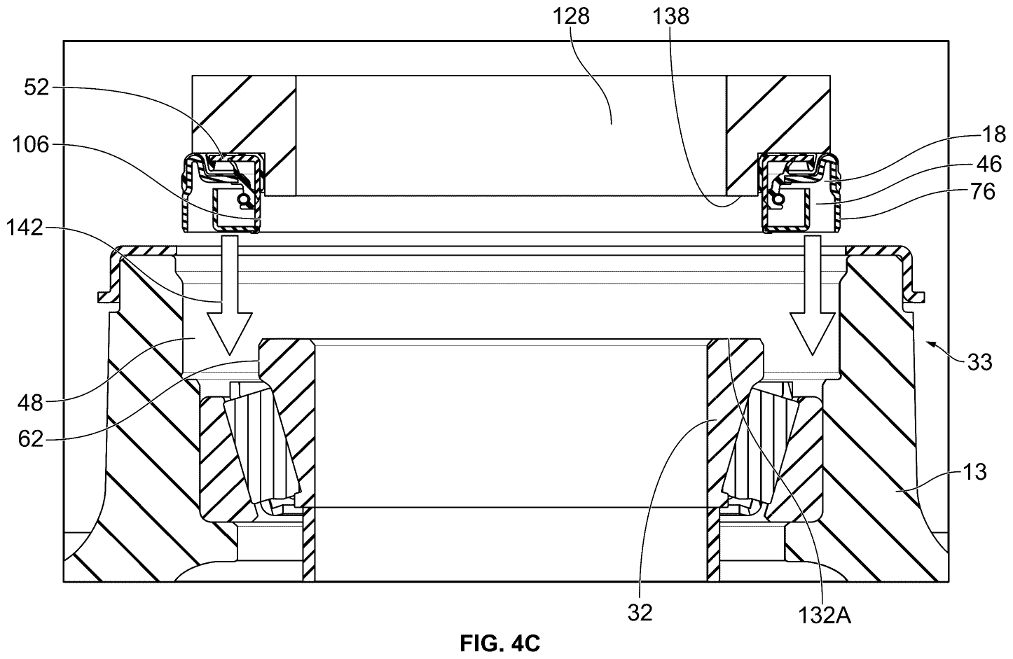

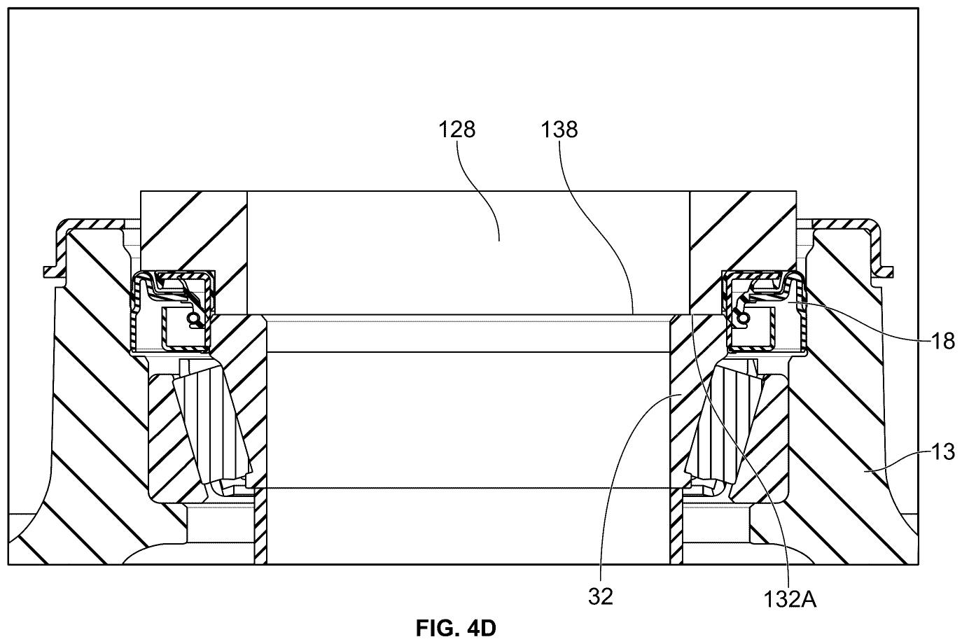

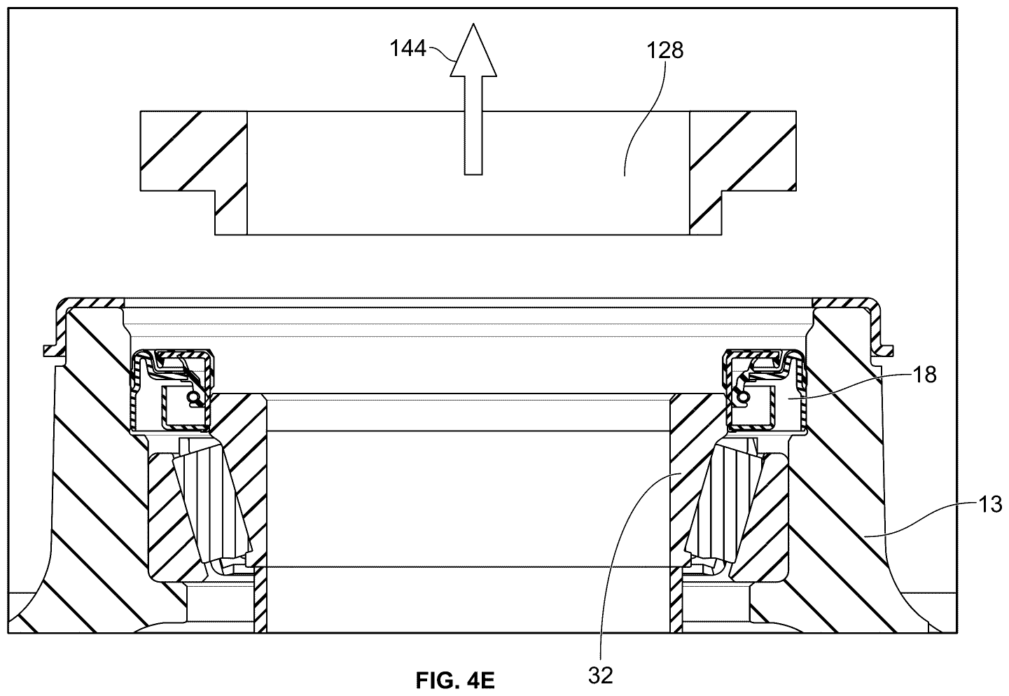

With respect to FIGS. 4A-4E, a method of installing the seal 18 and the wheel hub 12 is provided. To install the seal 18, an installation tool 128 may be used to press the seal 18 into a central opening 129 (see FIG. 3) of the wheel hub body 13 and onto the flange portion 38 of the inboard bearing cone 32. The installation tool 128 includes an annular body 130 having a larger diameter portion 132 and a smaller diameter portion 134 extending axially from the larger diameter portion 132. The smaller diameter portion 134 is sized to be inserted into the central opening 60 of the seal 18 to temporarily mount the seal 18 to the installation tool 128.

With reference to FIG. 4B, the smaller diameter portion 134 of the installation tool 128 is configured to engage the axially extending portion of the sealing member 102 of the sleeve 52 to form a friction fit connection therebetween. Alternatively or additionally, the installation tool 128 may include magnets that hold the seal 18 to the installation tool 128. The annular body 130 may be sized to be inserted into the inboard end portion 33 of the wheel hub 12. The larger diameter portion 132 extends radially outward of the smaller diameter portion 134 and includes a pressing surface 136 to contact both the seal case 46 and the sleeve 52 as the seal 18 is pressed into the wheel hub 12. The pressing surface 136 applies an axial force in the outboard direction 142 (see FIG. 4C) against both the seal case 46 and sleeve 52 during installation of the seal 18 into the wheel hub body 13. Because the seal case 46 and sleeve 52 are urged together by the pressing surface 136, the installation tool 128 maintains an axial spacing between the seal case 46 and sleeve 52 during installation of the seal 18. The smaller diameter portion 134 includes a stop surface 138 (e.g., at the terminal end of the smaller diameter portion 134) to contact an inboard end 132A (see FIG. 4C) of the inboard bearing cone 32 and limit insertion of the seal 18 in direction 142 into the wheel hub body 13. The axial position of the stop surface 138, which urges the seal 18, relative to the pressing surface 136, which abuts the inboard bearing cone 32, thereby sets the position of the seal 18 in the wheel hub 12.

With reference to FIG. 4A, the seal 18 may be mounted to the installation tool 128 by inserting the smaller diameter portion 134 of the installation tool 128 into the central opening 60 of the seal 18. For example, the central opening 60 of the seal 18 may be aligned with the smaller diameter portion 134 of the installation tool 128 and the seal 18 moved in direction 140 to mount the seal 18 on the installation tool 128. The smaller diameter portion 134 may frictionally engage the sealing member 102 of the sleeve 52 to secure the seal 18 to the installation tool 128. The seal 18 may be advanced onto the smaller diameter portion 134 until the seal case 46 and sleeve 52 contact the pressing surface 136 of the larger diameter portion 132 of the installation tool 128 as shown in FIG. 4B.

Regarding FIG. 4C, once the seal 18 is mounted to the installation tool 128, the installation tool 128 is inserted into the inboard end portion 33 of the wheel hub body 13. The radially outer portion 76 of the seal case 46 is concentrically aligned with the radially inner surface 48 of the wheel hub 12 and the axial wall portion 106 of the sleeve 52 is concentrically aligned with the flange portion 38 of the inboard bearing cone 32. Force is applied in direction 142 to urge the seal case 46 along the radially inner surface 48 of the wheel hub body 13 and urge the sleeve 52 along the engagement surface 62 of the flange portion 38 of the inboard bearing cone 32 until the into the stop surface 138 of the installation tool abuts the inboard end 132A of the inboard bearing cone 32 as shown in FIG. 4D. The force to press seal 18 into the wheel hub 12 may be significant, for example, about 2,000-4000 lbf. When the stop surface 138 of the installation tool 128 contacts the inboard bearing cone 32, the sleeve 52 is at its proper axial position along the flange portion 38 of the inboard bearing cone 32, with the sealing portion 90 of the seal case 46 aligned in a radial direction with the flange portion 38 of the bearing cone 32 as discussed above.

With respect to FIG. 4E, once the seal 18 is inserted in the wheel hub body 13, the installation tool 128 may be moved in direction 144 to withdraw the installation tool 128 from the wheel hub body 13. The frictional resistance between the installation tool 128 and the seal 18 is significantly less than the frictional resistance of the metal-to-metal interference fit connection of the sleeve 52 with the inboard bearing cone 32. The installation tool 128 is thereby able to be withdrawn from the seal 18 without moving the seal 18, which leaves the seal 18 mounted at the proper position in the wheel hub body 13.

Regarding FIG. 2, the wheel hub assembly 10 may then be installed on the spindle 21 by aligning the central bore 22 of the inboard bearing assembly 16 of the wheel hub assembly 10 with an outboard end of the spindle 21 and advancing the wheel hub assembly 10 in direction 26 along the spindle 21 by tightening the spindle nut 36. Advancing the wheel hub assembly 10 in direction 26 along the spindle 21 brings the seal member 102 of the sleeve 52 into frictional contact with the seal journal 24 of the spindle 21. Conversely, removing the wheel hub assembly 10 in direction 26A along the spindle 21 slides the seal member 102 of the sleeve 52 off of the seal journal 24.

Because the seal member 102 of the sleeve 52 contacts the seal journal 24 rather than the body 100, the frictional force required to advance the wheel hub assembly 10 onto the spindle 21 is significantly less than in other seals that have a metal-to-metal interference fit connection between a metallic sleeve of a seal and an associated spindle (e.g., a frictional force of 50-500 lbf). For example, the wheel hub assembly 10 may be advanced to an installed position on the spindle 21 with the sleeve sealing member 102 engaged with the seal journal 24 (see FIG. 3) by applying a torque in the range of 2-20 ft-lbf to the spindle nut 36. The reduced frictional force to move the wheel hub assembly 10 along the spindle 21 in directions 26, 26A not only makes installation easier but also makes it easier to remove the wheel hub assembly 10 from the spindle 21, for example, to service the wheel hub assembly 10. Specifically, less force is required to slide the seal 18 off the spindle 21, enabling the seal 18 to be removed from the spindle 21 without damage to the seal 18, which may permit the seal 18 to be reused.

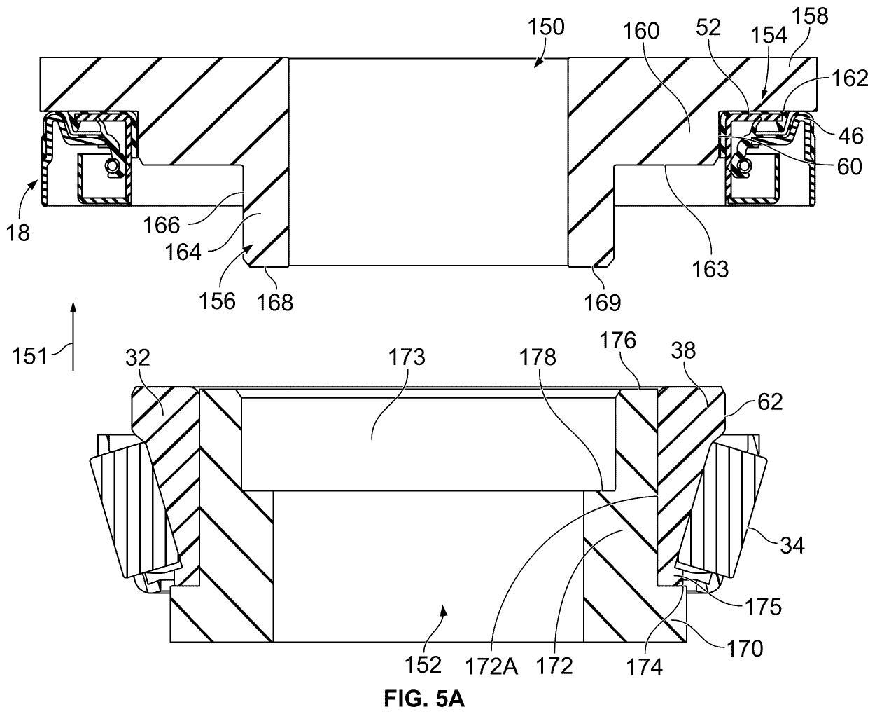

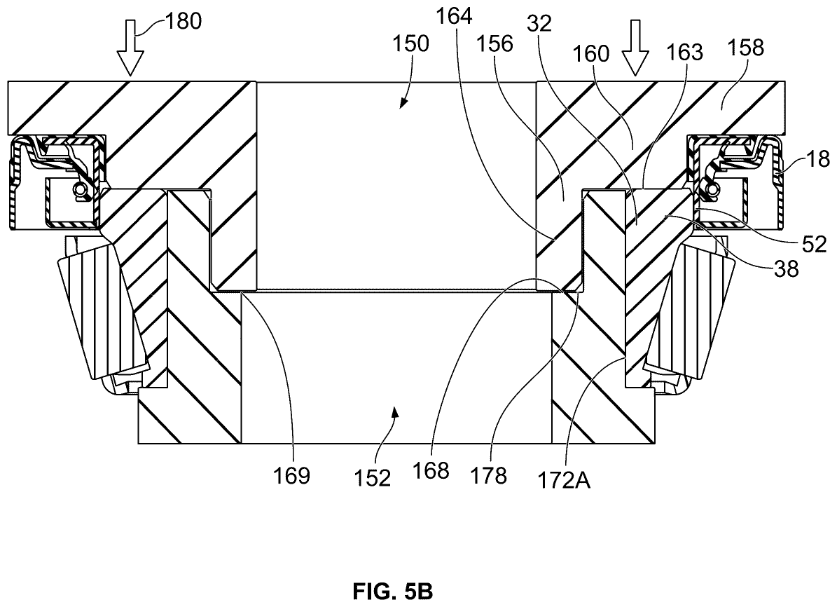

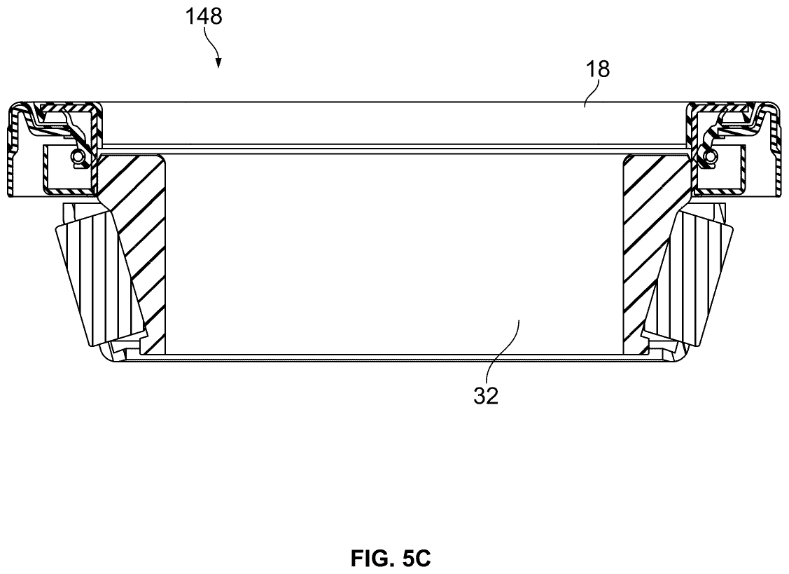

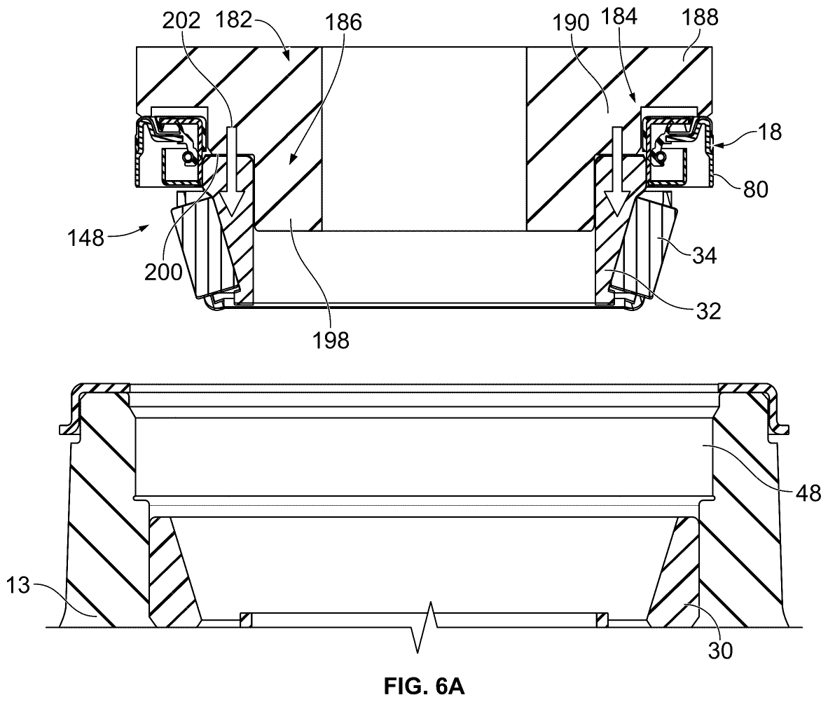

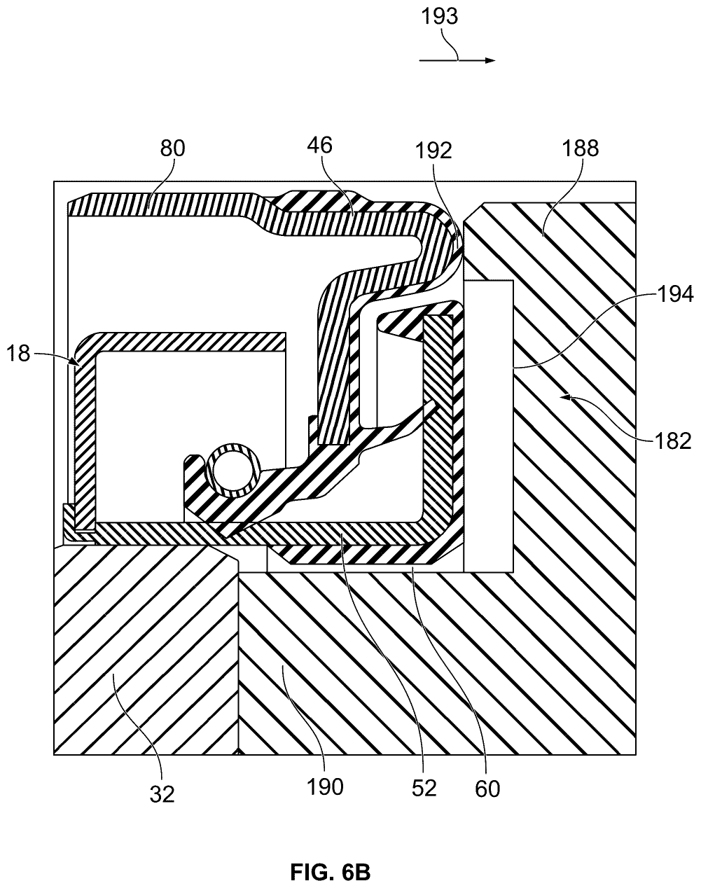

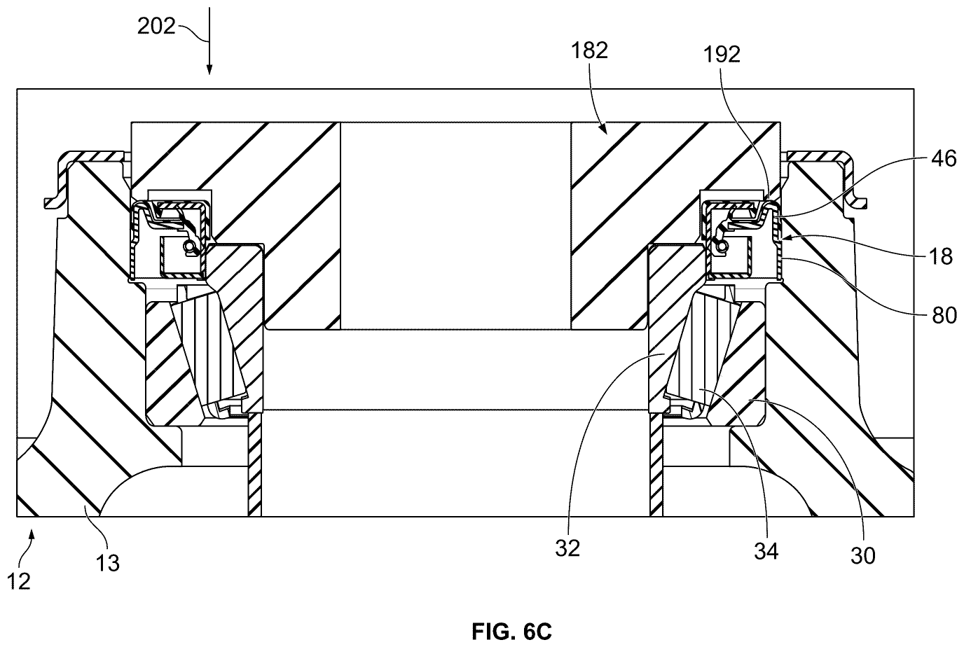

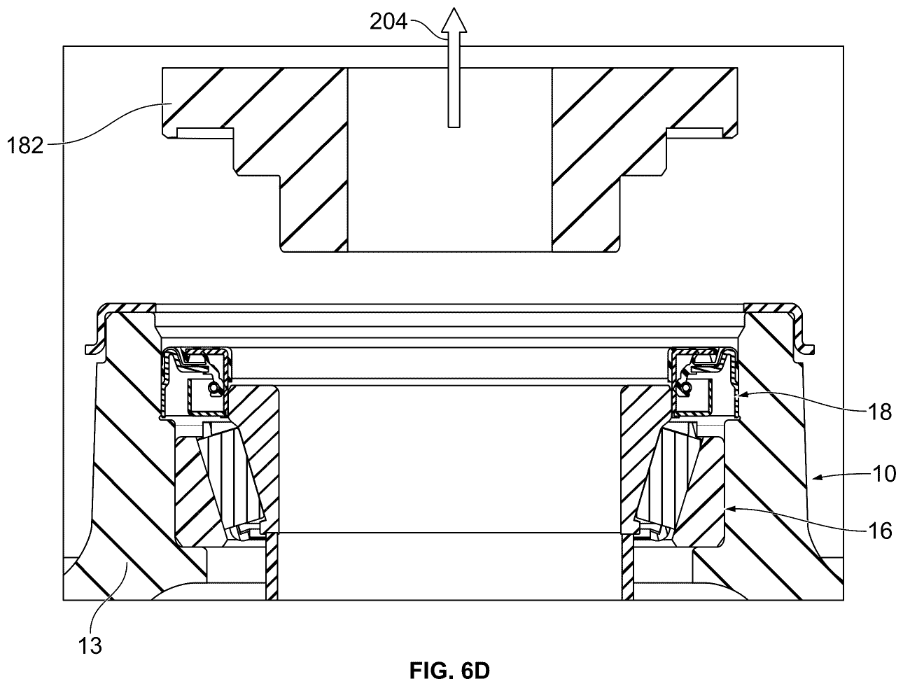

With respect to FIGS. 5A-6D, another method of installing the seal 18 in the wheel hub body 13 is provided according to another approach. Regarding FIG. 5A, the seal 18 is mounted to the inboard bearing cone 32 of the inboard bearing assembly 16 to form a seal and bearing cone assembly 148 as shown in FIG. 5C. The seal and bearing cone assembly 148 is then inserted into the wheel hub body 13 to assemble the inboard bearing assembly 16 and install the seal 18 to the wheel hub body 13 as shown in FIGS. 6A-6D.

More specifically and with respect to FIG. 5A, the seal 18 is mounted on a first assembly tool 150 and the inboard bearing cone 32 and roller bearings 34 of the inboard bearing assembly 16 are mounted on a second assembly tool 152. The first assembly tool 150 cooperates with the second assembly tool 152 to press the seal 18 onto the flange portion 38 of the inboard bearing cone 32.

The first assembly tool 150 includes a seal mounting portion 154 and an alignment portion 156. The seal mounting portion 154 includes a larger diameter portion 158 and a smaller diameter portion 160 extending axially from the larger diameter portion 158. The smaller diameter portion 160 is sized to extend into the central opening 60 of the seal 18 to form a friction fit connection and temporarily retain the seal 18 on the first assembly tool 150. The seal 18 may be advanced in direction 151 onto the smaller diameter portion 160 until the seal 18 contacts a pressing surface 162 of the larger diameter portion 158. The pressing surface 162 of the larger diameter portion 158 contacts both the sleeve 52 and the seal case 46, for example, the radially extending portion 108 (see FIG. 3) of the sleeve 52 and the bend 79 of the seal case 46. The pressing surface 162 of the larger diameter portion 158 maintains the axial spacing between the seal case 46 and the sleeve 52 as the sleeve 52 is pressed onto the inboard bearing cone 32.

Regarding FIG. 5A, the alignment portion 156 includes a stop surface 163 at the end of the smaller diameter portion 160 of the seal mounting portion 154. The stop surface 163 is positioned to contact the inboard bearing cone 32 when the inboard bearing cone 32 and seal 18 are pressed together to position the seal 18 on the inboard bearing cone 32. The alignment portion 156 further includes a guide portion 164 extending axially from the smaller diameter portion 160 to mate with the second assembly tool 152. The guide portion 164 may include an annular wall having an outer surface 166 to guide the inboard bearing cone 32 as the inboard bearing cone 32 and seal 18 are pressed together using the first assembly tool 150 and second assembly tool 152. The guide portion 164 mates with the second assembly tool 152 to concentrically align the first assembly tool 150 and the second assembly tool 152 as the first assembly tool 150 and second assembly tool 152 are pressed together. The guide portion 164 is configured to engage the second assembly tool 152 before the inboard bearing cone 32 contacts the seal 18 to ensure the seal 18 and inboard bearing cone 32 are properly aligned before the seal 18 is pressed on the inboard bearing cone 32. The guide portion 164 may be sized such that an end surface 169 of a leading end portion 168 of the guide portion 164 remains spaced from the second assembly tool 152 when the seal 18 is fully pressed onto the inboard bearing cone 32. Keeping the end surface 169 of the leading end portion 168 of the guide portion 164 spaced from the second assembly tool 152 ensures that the first assembly tool 150 and second assembly tool 152 apply pressing force to the seal 18 and inboard bearing cone 32 (rather than the other assembly tool 150, 152) to ensure proper placement of the seal 18 on the inboard bearing cone 32.

The second assembly tool 152 has a larger diameter portion 170 and a smaller diameter portion 172 extending axially from the larger diameter portion 170. The smaller diameter portion 172 is sized to extend into the central bore 22 of the inboard bearing cone 32 to hold the inboard bearing cone 32 on the second assembly tool 152. A cylindrical outer surface 172A of the smaller diameter portion 172 forms a friction fit connection with the inboard bearing cone 32. The inboard bearing cone 32 is advanced onto the smaller diameter portion 172 until an outboard end surface 175 of the inboard bearing cone 32 seats against a pressing surface 174 of the larger diameter portion 170. The smaller diameter portion 172 has an opening 173 to receive the guide portion 164 of the first assembly tool 150 as the seal 18 is pressed on the inboard bearing cone 32. The smaller diameter portion 172 of the second assembly tool 152 also includes a leading end portion 176 at the end of the smaller diameter portion 172 and a stepped surface 178. The leading end portion 176 and stepped surface 178 of the second assembly tool 152 remain spaced from the stop surface 163 and leading end portion 168 of the guide portion 164 of the first assembly tool 150, respectively, when the seal 18 is fully pressed onto the inboard bearing cone 32.

With respect to FIG. 5B, the first assembly tool 150 is moved in direction 180 toward the second assembly tool 152 to press the seal 18 onto the flange portion 38 of the inboard bearing cone 32 and form the seal and bearing cone assembly 148. A significant amount of force (e.g., 2,000-4,000 lbf) may be used to press the seal 18 onto the inboard bearing cone 32 due to interference between the sleeve body 100 of the seal 18 and the flange portion 38 of the inboard bearing cone 32. In one embodiment, the body 100 of the sleeve 52 is made of a metallic material and the metal-to-metal contact between the sleeve body 100 and the flange portion 38 of the inboard bearing cone 32 provides significant resistance to movement of the sleeve 52 onto and along the flange portion 38.

Regarding FIG. 5B, the guide portion 164 of the first assembly tool 150 is aligned with and inserted into the opening 173 of the second assembly tool 152. The first assembly tool 150 is urged toward the second assembly tool 152 until the stop surface 163 of the alignment portion 156 contacts the inboard bearing cone 32 and the force applied to press the seal 18 onto the inboard bearing cone 32 exceeds a force threshold, which indicates the seal 18 is fully pressed on the inboard bearing cone 32. The force to press the seal 18 onto the inboard bearing cone 32 increases upon the stop surface 163 contacting the inboard bearing cone 32 because the inboard bearing cone 32 is seated against the pressing surface 174 of the second assembly tool 152. An end surface 169 of leading end portion 168 of the alignment portion 156 of the first assembly tool 150 remains spaced from the stepped surface 178 of smaller diameter portion 172 of the second assembly tool 150 such that force is applied to the seal 18 and inboard bearing cone 32 and not to the first and second assembly tools 150, 152. In other forms, the first assembly tool 150 and second assembly tool 152 are configured to abut one another when the seal 18 is properly positioned on the inboard bearing cone 32 to inhibit pressing the seal 18 too far onto the inboard bearing cone 32.

With respect to FIG. 5C, upon pressing the seal 18 onto the inboard bearing cone 32, the first assembly tool 150 and second assembly tool 152 may be withdrawn from the seal and bearing cone assembly 148. The interference fit between the seal 18 and the inboard bearing cone 32 has a greater frictional resistance than that of the interface between the seal 18 and the first assembly tool 150 and the interference between the inboard bearing cone 32 and the second assembly tool 152. In this manner, the first and second assembly tools 150, 152 may be withdrawn without moving the seal 18 from its position on the inboard bearing cone 32.

With respect to FIG. 6A, an installation tool 182 may be used to press the seal and bearing cone assembly 148 of FIG. 5C into the wheel hub body 13. The installation tool 182 includes a seal receiving portion 184 and a bearing cone receiving portion 186. The seal receiving portion 184 includes a larger diameter portion 188 and a smaller diameter portion 190 extending axially from the larger diameter portion 188.

With reference to FIG. 6B, the larger diameter portion 188 includes a pressing surface 192 positioned to contact the seal case 46 of the seal 18 to urge the seal case 46 along the radially inner surface 48 of the wheel hub body 13. The larger diameter portion 188 includes an annular recess 194 to be aligned with the sleeve 52 of the seal 18 to limit contact between the installation tool 182 and the sleeve 52. The pressing force applied by the installation tool 182 to the seal 18 is thus focused at the pressing surface 192 that contacts the seal case 46. The annular recess 194 inhibits the sleeve 52 from shifting in direction 193 relative to the inboard bearing cone 32 as the seal and bearing cone assembly 148 is pressed into the wheel hub body 13. In other words, the installation tool 182 is configured to apply force to the seal case 46 to overcome the frictional resistance between the seal case 46 and the wheel hub body 13 while avoiding contact with the sleeve 52. The smaller diameter portion 190 has an outer diameter sized to be inserted into the central opening 60 of the seal 18 and to retain the seal 18 thereon by a friction fit. Alternatively or additionally, the installation tool 182 may include magnets that hold the seal and bearing cone assembly 148 to the installation tool 182.

Returning to FIG. 6A, the bearing cone receiving portion 186 includes a mounting portion 198 and a stop surface 200. The mounting portion 198 has an outer diameter sized to be inserted into the inboard bearing cone 32 and may retain the inboard bearing cone 32 thereon by a friction fit. The mounting portion 198 may be inserted in the inboard bearing cone 32 until the stop surface 200 abuts the inboard bearing cone 32.

With the seal and bearing cone assembly 148 mounted on the installation tool 182, the installation tool 182 may be moved in direction 202 to press the seal and bearing cone assembly 148 into the wheel hub body 13 and seat the roller bearings 34 in the inboard bearing cup 30. Regarding FIGS. 6B and 6C, the radially outer portion 80 of the seal case 46 is urged along the radially inner surface 48 of the wheel hub body 13 by the pressing surface 192 of the installation tool 182.

With respect to FIG. 6C, the installation tool 182 is pressed in direction 202 until the roller bearings 34 contact the inboard bearing cup 30. A significant amount of force (e.g., 2,000-4,000 lbf) may be used to press the seal and bearing cone assembly 148 into the inboard bearing cup 30. With respect to FIG. 6D, the installation tool 182 may then be moved in direction 204 to withdraw the installation tool 182 from the wheel hub assembly 10.

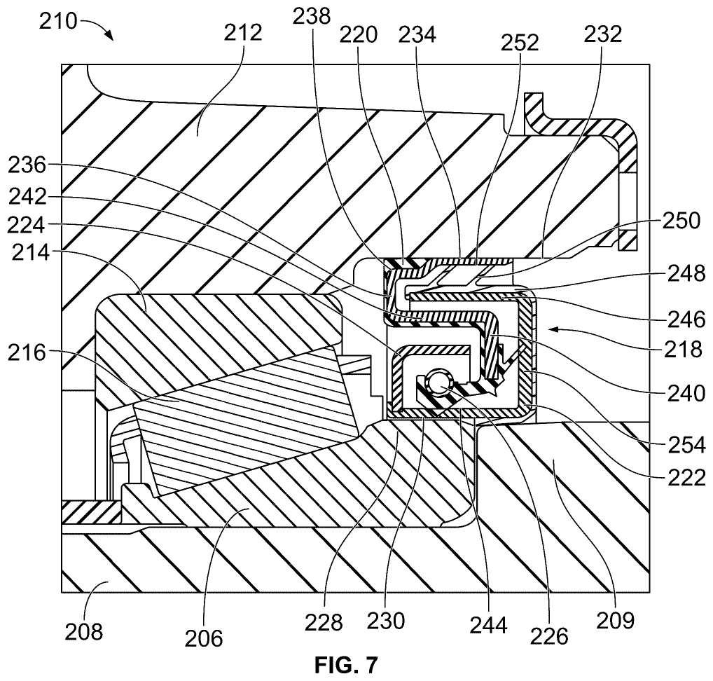

With respect to FIG. 7, a wheel hub assembly 210 is provided that is similar to the wheel hub assembly 10 discussed above such that the differences will be highlighted. The wheel hub assembly 210 is mounted to a spindle 208. The wheel hub assembly 210 includes a hub body 212, an inboard bearing cup 214, roller bearings 216, and an inboard bearing cone 206. The wheel hub assembly 210 includes a seal 218 having a seal case 220, a sleeve 222, a retainer 224, and a garter spring 226. The inboard bearing cone 206 includes a flange portion 228 having an engagement surface 230. The sleeve 222 of the seal 218 forms a press-fit engagement with the engagement surface 230 of the flange portion 228. The seal case 220 has an outer diameter sized to form a press-fit engagement with a radially inner surface 232 of the hub body 212.

The seal 218 is similar in many respects to the seal 18 discussed above with the main differences being the structure of the seal 218. In seal 218, the seal case 220 includes a radially outer portion 234, an intermediate portion 236 that includes a bend 238 and a radially inner portion 240. The bend 238 of the intermediate portion 236 is at the outboard side of the seal 218 with the radially outer portion 234 extending in an inboard direction from the intermediate portion 236 along the radially inner surface 232 of the hub body 212. The intermediate portion 236 includes a support 242 that extends in the inboard direction from the bend 238 to support the radially inner portion 240 in engagement with a seal surface 244 of the sleeve 222, radially outward of and aligned with the flange portion 228 of the inboard bearing cone 206.

The sleeve 222 is similar to the sleeve 52 discussed above and further includes a radially outer portion 246 that extends in an outboard direction between the support 242 and the radially outer portion 234 of the seal case 220. The sleeve 222 includes a sealing member 248 that extends along the radially outer portion 246 of the sleeve 222 with seal walls 250 extending radially outward. The seal walls 250 extend radially outward to sealingly engage an inner surface 252 of the radially outer portion 234 of the seal case 220 to inhibit fluid and debris from passing between the sleeve 222 and the seal case 220. In one embodiment, the sleeve 222 includes a metallic body 254 that forms a metal-to-metal press fit connection with the flange portion 228 of the inboard bearing cone 206. The sealing member 248 of the sleeve 222 engages the spindle 208 and spaces the body 254 from the spindle 208.

The seal 218 may be pressed onto the inboard bearing cone 206 using approaches similar to those described above. The seal 218 may be pressed onto the inboard bearing cone 206 during assembly of the wheel hub assembly 210 such that lower forces can be used when mounting the wheel hub assembly 210 to the spindle 208, for example, to bring the seal 218 into position on a seal journal 209 of the spindle 208.

While there have been illustrated and described particular embodiments of the present invention, it will be appreciated that numerous changes and modifications will occur to those skilled in the art, and it is intended for the present invention to cover all those changes and modifications which fall within the scope of the appended claims. Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. It is intended that the phrase “at least one of” as used herein be interpreted in the disjunctive sense. For example, the phrase “at least one of A and B” is intended to encompass A, B, or both A and B.

What is claimed is:

1. A wheel hub assembly for mounting to a spindle of a vehicle, the wheel hub assembly comprising:
a wheel hub body having an interior, the wheel hub body having a wheel mounting portion for mounting a wheel thereto;
an inboard bearing assembly and an outboard bearing assembly in the interior of the wheel hub body for rotatably connecting the wheel hub body to the spindle;
the inboard bearing assembly having a radially outer ring mounted to the wheel hub body, a radially inner ring, and a plurality of bearing elements that permit the radially outer ring to rotate relative to the radially inner ring;
a seal including a seal case mounted to the wheel hub body and a sleeve having a sleeve body mounted to the radially inner ring of the inboard bearing assembly, the sleeve body having a central opening;
the radially inner ring of the inboard bearing assembly extending in the central opening of the sleeve body; and
the sleeve body extending inboard from the radially inner ring and configured to extend along the spindle and be spaced radially therefrom with the inboard and outboard bearing assemblies rotatably connecting the wheel hub body to the spindle.

2. The wheel hub assembly of claim 1 wherein the sleeve body includes an outboard portion radially intermediate portions of the radially inner ring and the wheel hub body.

3. The wheel hub assembly of claim 1 wherein the sleeve body has an interference fit with the radially inner ring of the inboard bearing assembly.

4. The wheel hub assembly of claim 1 wherein the radially inner ring has a maximum outer diameter that is smaller than an inner diameter of the central opening of the sleeve body.

5. The wheel hub assembly of claim 1 wherein the sleeve includes a sealing member configured to be radially intermediate the sleeve body and the spindle with the inboard and outboard bearing assemblies rotatably connecting the wheel hub body to the spindle.

6. The wheel hub assembly of claim 1 wherein the wheel hub body is rotatable around the spindle about an axis with the inboard and outboard bearing assemblies connecting the wheel hub body to the spindle;
wherein the sleeve body has an outboard portion fixed to the radially inner ring and an inboard portion inboard of the radially inner ring;
wherein the sleeve includes a sealing member radially aligned with the inboard portion of the sleeve body and configured to be radially intermediate the inboard portion and the spindle; and
wherein the sleeve includes an axial, radially inner wall that includes both the outboard and inboard portions of the sleeve body.

7. The wheel hub assembly of claim 1 wherein the sleeve body includes a radially inner surface portion engaged with the radially inner ring and a radially outer surface portion opposite the radially inner surface portion; and
wherein the seal case includes a sealing member configured to slidingly contact the radially outer surface portion of the sleeve upon rotation of the wheel hub body relative to the radially inner ring.

8. The wheel hub assembly of claim 7 wherein the sealing member slidingly contacts the radially outer surface portion of the sleeve radially aligned with the radially inner surface portion of the sleeve body.

9. The wheel hub assembly of claim 1 wherein the sleeve body is metallic; and
wherein the seal case includes a sealing member having a contact portion that engages the metallic sleeve body opposite the radially inner ring such that the metallic sleeve body has a portion thereof radially intermediate the radially inner ring and the contact portion of the seal case sealing member.

10. The wheel hub assembly of claim 1 wherein the radially inner ring of the inboard bearing assembly includes a flange portion, the sleeve body mounted to the flange portion of the radially inner ring.

11. A cassette seal for a wheel hub assembly including a wheel hub body having an interior and a bearing assembly for being received in the interior and rotatably connecting the wheel hub body to a spindle, the bearing assembly including a radially inner ring, the cassette seal comprising:
a seal case having a radially outer portion to engage a radially inner surface of the interior of the wheel hub body; and
a sleeve including a sleeve body having an outboard portion with a central opening sized to receive an inboard portion of the radially inner ring and form an interference fit therewith, the sleeve body having an inboard portion configured to extend inboard of the inboard portion of the radially inner ring and be spaced radially from the spindle.

12. The cassette seal of claim 11 wherein the sleeve body is metallic; and
wherein the sleeve includes a sealing member radially inward of the inboard portion of the metallic sleeve body to sealingly engage the spindle.

13. The cassette seal of claim 11 wherein the sleeve body includes a radially inner surface portion configured to engage the inboard portion of the radially inner ring and form the interference fit therewith; and
wherein the seal case includes a seal member for engaging a radially outer surface portion of the sleeve radially aligned with the inboard portion of the radially inner ring.

14. The cassette seal of claim 11 wherein the outboard portion of the sleeve body has a first inner diameter and the sleeve includes an inboard section having a second inner diameter smaller than the first inner diameter.

15. The cassette seal of claim 14 further comprising a sealing member supported by the sleeve body, the sealing member having the second inner diameter.

16. A method of assembling a wheel hub assembly, the wheel hub assembly comprising:
a wheel hub body having an interior and a wheel mounting portion;
inboard and outboard bearing assemblies for being received in the interior of the wheel hub body and rotatably connecting the wheel hub body to a spindle of a vehicle;
a bearing assembly having a radially outer ring, a radially inner ring, and a plurality of bearing elements that permit the radially outer ring to rotate relative to the radially inner ring; and
a seal comprising a sleeve and a seal case rotatable about the sleeve, the sleeve including a sleeve body;
the method comprising:
aligning a central opening of the sleeve with the radially inner ring of the bearing assembly; and
advancing the radially inner ring and the seal relative to one another to form an interference fit between the radially inner ring and the sleeve body with the sleeve body having a radially inner portion engaged with a radially outer portion of the radially inner ring and with an inboard portion of the sleeve body extending inboard from the radially inner ring and configured to extend along the spindle and be spaced radially therefrom with the inboard and outboard bearing assemblies rotatably connecting the wheel hub body to the spindle.

17. The method of claim 16 further comprising positioning a sealing member of the seal case in radial alignment with the radially outer portion of the radially inner ring so that the sleeve is radially intermediate the sealing member and the radially outer portion of the radially inner ring.

18. The method of claim 16 wherein advancing the radially inner ring and seal relative to one another includes advancing the seal in an outboard direction in the interior of the wheel hub body.

19. The method of claim 16 further comprising positioning the seal on a tool having a pressing surface to contact the sleeve and the seal case and a stop extending in the central opening of the sleeve; and
wherein advancing the seal relative to the radially inner ring includes urging the pressing surface of the tool against the sleeve and the seal case until the stop contacts the radially inner ring.

20. The method of claim 16 wherein advancing the radially inner ring and seal relative to one another comprises forming a seal and bearing assembly; and
wherein the method further comprises advancing the seal and bearing assembly in an outboard direction into the interior of the wheel hub body to engage a radially outer portion of the seal case with a radially inner surface of the wheel hub body.

21. The method of claim 20 wherein the seal and bearing assembly includes the seal, the radially inner ring, and the plurality of bearing elements; and
wherein advancing the seal and bearing assembly includes advancing the seal and bearing assembly until the plurality of bearing elements contact the radially outer ring mounted to the wheel hub body.

22. The method of claim 20 further comprising positioning the seal and bearing assembly on a tool having a pressing surface to contact the seal case; and
wherein advancing the seal and bearing assembly includes urging the pressing surface of the tool against seal case to slide the radially outer portion of the seal case along the radially inner surface of the wheel hub body.
